(19) United States
(12) Patent Application Publication
(10) Pub. No.: US 2023/0040033 A1
(43) Pub. Date: Feb. 9, 2023

(54) Full Blackout Anti-haze Noise-reducing Thermal Insulation Curtain and Its Production Method

(71) Applicant: Zhiliang WU, Zhejiang (CN)

(72) Inventor: Zhiliang WU, Zhejiang (CN)

(21) Appl. No.: 17/396,749

(22) Filed: Aug. 8, 2021

(51) Int. Cl. A47H 23/08; A47H 13/02; B32B 7/06; B32B 5/26; B32B 5/02

(52) U.S. Cl. CPC A47H 23/08; A47H 13/02; B32B 7/06; B32B 5/265; B32B 5/022; B32B 2307/102; B32B 2307/40; B32B 2307/304; B32B 2262/062; B32B 2451/00

(57) ABSTRACT

The invention herein provides a full blackout anti-haze noise-reducing thermal insulation curtain. The said full blackout anti-haze noise-reducing thermal insulation curtain includes mutually symmetrical first shade fabric and second shade fabric. With the first shade fabric and the second shade fabric, the invention can achieve 100% blackout, which can effectively protect against ultraviolet rays, block the sunlight and provide thermal insulation. Between the said first shade fabric and the second shade fabric is a removable lining, which is easy to clean. The said lining is a sound-proofing felt fabric. By using porous sound-absorbing material and the fabric structures, it can effectively regulate the indoor sound environment and reduce sound and noise. A number of rings are mounted correspondingly at the top of the first shade fabric and the second shade fabric, which make the removal of the curtain fabric easy when it is used as a curtain.

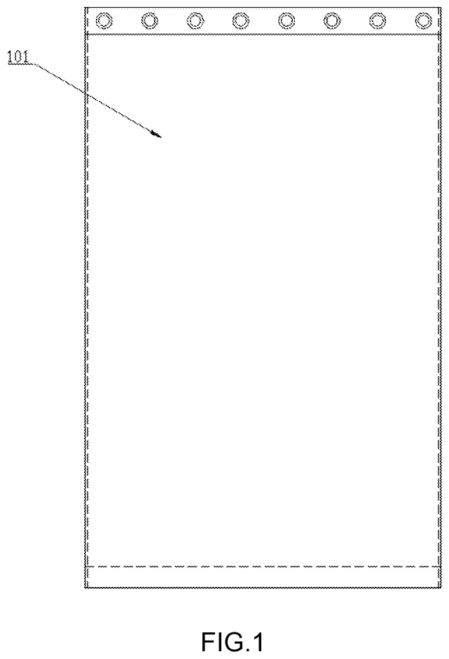

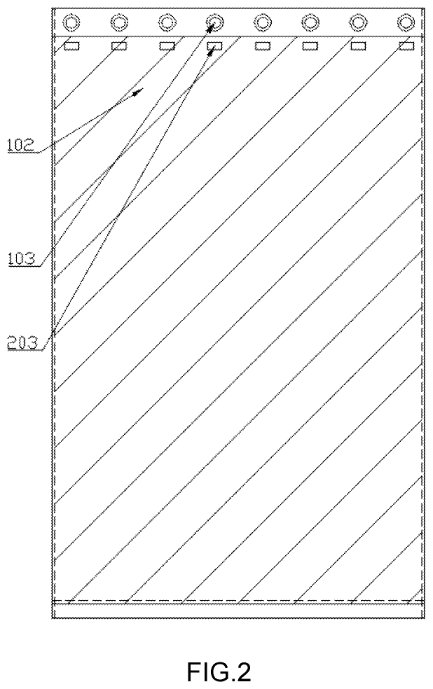

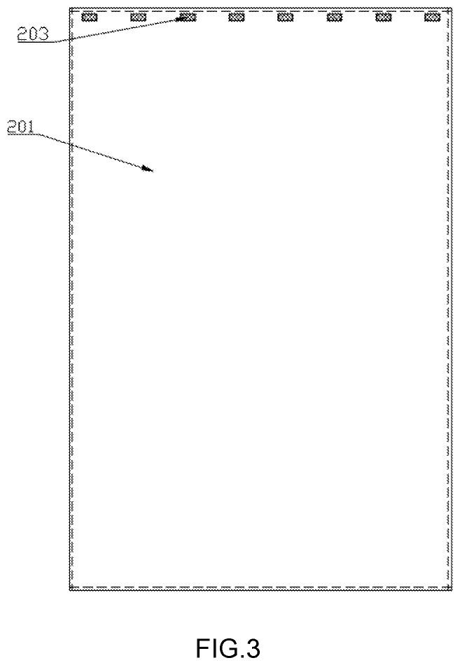

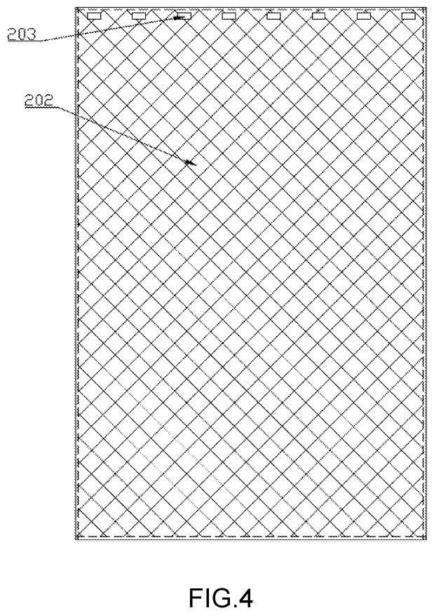

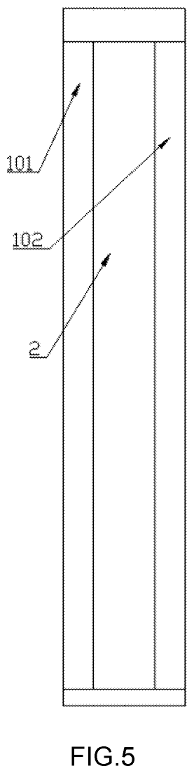

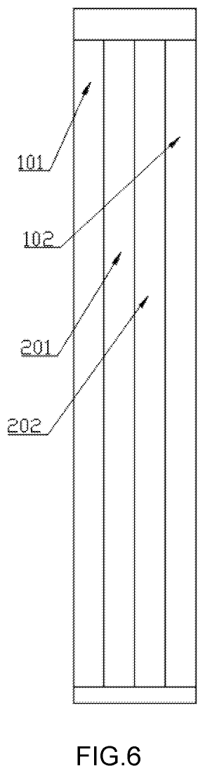

### BACKGROUND OF THE INVENTION

The invention involves the technical field of home decoration, specifically a full blackout anti-haze noise-reducing thermal insulation curtain and its production method.

Window shades are widely used, usually in residential buildings. Window shades are made of cloth, linen, yarn, aluminum, wood, metal materials, etc., having the functions of shading, thermal insulation and regulating indoor light. Fabric curtains include cotton gauze, polyester fabric, polyester-cotton blended fabric, cotton-linen blend fabric, non-woven fabric, etc. in terms of materials. Different materials, textures, colors, patterns, etc. are combined to form different styles of fabric curtains. However, curtain fabrics have the following problems: firstly, the existing curtain fabric cannot achieve full blackout when it is used to block sunlight, unable to meet the general consumer demand for full blackout curtains. Secondly, the existing curtain fabric is not good enough to prevent haze when the window is open, unable to effectively ward off PM2.5 particles, thus unable to reduce the impact of PM2.5 particulates on human cardiovascular and respiratory system. Thirdly, the existing curtain fabric is not sound-proofing and cannot reduce noise when the window is open. Therefore, consumers need a full blackout curtain fabric that can effectively prevent haze and reduce sound and noise.

### BRIEF SUMMARY OF THE INVENTION

To solve the above problems, the invention herein provides a full blackout anti-haze noise-reducing thermal insulation curtain and its production method.

To solve the above problems, the invention herein provides a full blackout anti-haze noise-reducing thermal insulation curtain and its production method, including a mutually symmetrical first shade fabric and a second shade fabric. Between the first shade fabric and the second shade fabric is a removable lining. The lining comes with a sound-proofing felt fabric. A number of rings are mounted at the top of the first shade fabric.

Preferably, the lining further comprises meltblown fabric.

Preferably, the sound-proofing felt fabric is a porous sound-absorbing material, specifically, sound absorbing cotton.

Preferably, the lining is respectively connected to the first shade fabric by Velcro.

Preferably, the number of rings is 6, 8 or 10.

Preferably, the thickness of the sound-proofing felt fabric is 0.8 mm-1 mm and the thickness of the meltblown fabric is 0.5 mm-0.8 mm.

The method of producing the above-mentioned curtain fabric at least includes the following steps:

S1: Cut the first shade fabric and the second shade fabric to the required size.

S2: The sound-proofing felt fabric and meltblown fabric are combined with ultrasonic microwave composite technology. The material surfaces of the sound-proofing felt fabric and the meltblown fabric are fused together by transmission of high frequency vibration wave. Under the pressure, the material surfaces rub against each other to form a fusion between the molecular layers. Then cut the fabric to the required size.

S3: The sound-proofing felt fabric will be sewn with Velcro on one side and the first shade fabric will be sewn with Velcro on the side opposite the sound-proofing felt fabric. The sound-proofing felt fabric is connected to the first shade fabric with Velcro.

S4: Sew the cut first shade fabric with the second shade fabric and install different numbers of rings at the top of the first shade fabric according to the size of the curtain fabric.

S5: Pack the finished products in PV bags, stick the barcode and put it in storage.

Compared with the existing techniques, the beneficial effects of the invention herein are as follows:

1. With the first shade fabric and the second shade fabric, the invention can achieve 100% blackout, which can effectively protect against ultraviolet rays, block the sunlight and provide thermal insulation.

2. With the sound-proofing felt fabric and by using porous sound-absorbing material, the invention make full use of fabric structures to effectively regulate the indoor sound environment and reduce sound and noise.

3. With meltblown fabric, the invention can effectively reduce PM2.5 particulates from entering the room and hinder various pollutants (gases and particulates such as CO, SO2, NOx, NH3, VOCs and PM) from entering the room, reducing the impact on human cardiovascular and respiratory systems.

Other features and advantages of the invention will be described in detail in the subsequent section on implementation methods.

### BRIEF DESCRIPTION OF THE DRAWINGS

The drawings provide a further understanding of the invention and constitute part of the specification. They are used together with the implementation methods below to explain the invention. However, they do not constitute limit on the invention. In the drawings:

Drawing 1 is a schematic drawing of the front structure of the first shade fabric described in the invention.

Drawing 2 is a schematic drawing of the front structure of the second shade fabric described in the invention.

Drawing 3 is a schematic drawing of the front structure of the sound-proofing felt fabric described in the invention.

Drawing 4 is a schematic drawing of the front structure of the sound-proofing felt fabric described in the invention after being combined with the meltblown fabric with the ultrasonic microwave composite technology.

Drawing 5 is a schematic drawing of the three-layer cross-sectional structure of the curtain described in the invention.

Drawing 6 is a schematic drawing of the four-layer cross-sectional structure of the curtain described in the invention.

### MARKS IN THE DRAWINGS

101. the first shade fabric; 102. the second shade fabric; 2. lining; 201. sound-proofing felt fabric; 202. meltblown fabric; 103. rings; 203. Velcro.

### DETAILED DESCRIPTION OF THE INVENTION

The method of implementing the invention is described in detail below with the drawings. It should be understood that the implementation method described herein is intended to illustrate and explain the invention only with no intention to limit the invention.

In the invention, unless expressed otherwise, orientation terms such as “upper, lower, left and right” usually refer to the upper, lower, left and right as shown with reference to the drawings, and “inner and outer” refer to the inner and outer contours of each part relative to the parts themselves.

As shown in Drawings 1-5, the invention provides a full blackout anti-haze noise-reducing thermal insulation curtain, including the first shade fabric 101 and the second shade fabric 102 symmetrical to each other. With the first shade fabric 101 and the second shade fabric 102, the curtain can achieve 100% blackout. It can effectively protect against ultraviolet rays, block the sunlight, and provide thermal insulation function. Between the first shade fabric 101 and the second shade fabric 102 is the removable lining 2. The removable feature makes it easy to clean. The lining 2 include the sound-proofing felt fabric 201. By using porous sound-absorbing material, the invention makes full use of fabric structures to effectively regulate the indoor sound environment and reduce sound and noise. A number of rings 103 are mounted at the top of the first shade fabric 101, which make the removal of the curtain fabric easy when it is used as a curtain.

Further, as shown in Drawing 6, lining 2 also includes meltblown fabric 202, which can effectively reduce PM2.5 particulates entering into the room and hinder various pollutants (gases and particulates such as CO, SO2, NOx, NH3, VOCs, PM) into the room, reducing the impact on the human cardiovascular and respiratory system.

Further, as shown in Drawing 3, the sound-proofing felt fabric 201 is a porous sound-absorbing material, specifically, sound-absorbing cotton. By using porous sound-absorbing material, the invention effectively use the structure of the fabric to regulate the indoor sound environment, so that the sound-proofing and noise-reducing feature of the sound-proofing felt fabric can be better exerted.

Further, as shown in Drawings 1-4, lining 2 is connected to the first shade fabric 101 by Velcro 203 respectively, which can make the removal and cleaning of the lining easier.

Further, as shown in Drawings 1 and 2, the number of rings 103 is eight, and further the number of rings 103 can also be 6 or 10 to make removal of the curtain easier. It can make the curtain installed more firmly, but does not make users feel troublesome when they remove the curtain.

Further, as shown in Drawing 6, the thickness of the sound-proofing felt fabric 201 is 0.8 mm-1 mm and the thickness of the meltblown fabric 202 is 0.5 mm-0.8 mm, which improve the features of the sound-proofing felt fabric 201 and meltblown fabric 202 without affecting the feeling of the user.

The method of producing the above-mentioned curtain fabric at least includes the following steps:

S1: Cut the first shade fabric 101 and the second shade fabric 102 to the required size.

S2: The sound-proofing felt fabric 201 and meltblown fabric 202 are combined with ultrasonic microwave composite technology. The material surfaces of the sound-proofing felt fabric 201 and the meltblown fabric 202 are fused together by transmission of high frequency vibration wave. Under the pressure, the material surfaces rub against each other to form a fusion between the molecular layers. Then cut the fabric to the required size.

S3: The sound-proofing felt fabric 201 will be sewn with Velcro on one side and the first shade fabric 101 will be sewn with Velcro on the side opposite the sound-proofing felt fabric 201. The sound-proofing felt fabric 201 is connected to the first shade fabric 101 with Velcro 203.

S4: Sew the cut first shade fabric 101 with the second shade fabric 102 and install different numbers of rings 103 at the top of the first shade fabric according to the size of the curtain fabric.

S5: Pack the finished products in PV bags, stick the barcode and put it in storage.

With the ultrasonic microwave composite technology, the production of curtain fabric is faster and more energy-efficient. It improves the fusion strength of the curtain fabric. The production process is spark-free. It is almost cold processing. All these features make the whole curtain fabric production process safer.

Preferred method of implementation of the invention is described in detail above with the drawings. The invention is not limited to the specific details in the above-mentioned implementation method. Within the technical conception of the invention, a number of simple changes of the technical solution of the invention can be made, all of which fall within the scope of protection of the invention.

It should also be noted that each of the specific technical features described in the above detailed implementation method can be combined in any suitable way if they do not contradict each other. To avoid unnecessary repetition, various possible combinations of the invention are not described separately.

Furthermore, any combination between the different implementation methods of the invention is possible. As long as they do not contradict the idea of the invention, they shall be considered as information disclosed herein.

What is claimed is:

1. A full blackout anti-haze noise-reducing thermal insulation curtain, of which the features include: mutually symmetrical first shade fabric and second shade fabric. Between the first shade fabric and the second shade fabric is a removable lining, which includes sound-proofing felt fabric. A number of rings are installed at the top of the said first shade fabric.

2. A full blackout anti-haze noise-reducing thermal insulation curtain as described in claim 1, of which the features include: the said lining also includes meltblown fabric.

3. A full blackout anti-haze noise-reducing thermal insulation curtain as described in claim 1, of which the features include: the said sound-proofing felt fabric is a porous sound-absorbing material, specifically, sound-absorbing cotton.

4. A full blackout anti-haze noise-reducing thermal insulation curtain as described in claim 1, of which the features include: the said lining is connected to the first shade fabric by Velcro respectively.

5. A full blackout anti-haze noise-reducing thermal insulation curtain as described in claim 1, of which the features include: the number of the said rings is 6, 8 or 10.

6. A full blackout anti-haze noise-reducing thermal insulation curtain as described in claim 2, of which the features include: the thickness of the said sound-proofing felt fabric is 0.8 mm-1 mm, and the thickness of the said meltblown fabric is 0.5 mm-0.8 mm.

7. The method of producing the above-mentioned full blackout anti-haze noise-reducing thermal insulation curtain at least includes the following steps:
S1: Cut the first shade fabric and the second shade to the required size.
S2: The sound-proofing felt fabric and meltblown fabric are combined with ultrasonic microwave composite technology. The material surfaces of the sound-proofing felt fabric and the meltblown fabric are fused together by transmission of high frequency vibration wave. Under the pressure, the material surfaces rub against each other to form a fusion between the molecular layers. Then cut the fabric to the required size.
S3: The sound-proofing felt fabric will be sewn with Velcro on one side and the first shade fabric will be sewn with Velcro on the side opposite the sound-proofing felt fabric. The sound-proofing felt fabric is connected to the first shade fabric with Velcro.
S4: Sew the cut first shade fabric with the second shade fabric and install different numbers of rings at the top of the first shade fabric according to the size of the curtain fabric.
S5: Pack the finished products in PV bags, stick the barcode and put it in storage.
